(19) United States
(12) Patent Application Publication
(10) Pub. No.: US 2025/0071841 A1
(43) Pub. Date: Feb. 27, 2025

(54) DEVICE AND METHOD FOR PROCESSING CONNECTION FAILURE DURING COMMUNICATION BETWEEN DONOR NODES, IN BACKHAUL AND ACCESS HOLE COMBINATION SYSTEM

(71) Applicant: Samsung Electronics Co., Ltd., Suwon-si, Gyeonggi-do (KR)

(72) Inventor: June HWANG, Suwon-si (KR)

(21) Appl. No.: 18/725,554

(22) PCT Filed: Jan. 3, 2023
(86) PCT No.: PCT/KR2023/000061

§ 371 Date: Jun. 28, 2024

(30) Foreign Application Priority Data
Jan. 3, 2022 (KR) 10-2022-0000423

(51) Int. Cl. H04W 76/18

(52) U.S. Cl. CPC H04W 76/18

(57) ABSTRACT

The present disclosure relates to: a communication technique for combining IoT technology with a 5G communication system for supporting a higher data transmission rate than 4G systems; and a system therefor. The present disclosure can be applied to intelligent services (for example, smart home, smart building, smart city, smart car or connected car, healthcare, digital education, retail, security- and safety-related services, etc.) on the basis of 5G communication technology and IoT-related technology. Disclosed in the present disclosure are a method and device which can prevent a packet routing failure in a backhaul and access haul combination system.

### TECHNICAL FIELD

The disclosure relates to an integrated access and backhaul (IAB) system.

### BACKGROUND ART

To meet the ever increasing demand for wireless data traffic since the commercialization of 4th generation (4G) communication systems, efforts have been made to develop improved 5th generation (5G) or pre-5G communication systems. As such, 5G or pre-5G communication systems are also called “beyond 4G network system” or “post Long Term Evolution (LTE) system”. To achieve high data rates, 5G communication systems are being considered for implementation in the extremely high frequency (mmWave) band (e.g., 60 GHz band). To decrease path loss of radio waves and increase the transmission distance thereof in the mmWave band, various technologies including beamforming, massive multiple-input multiple-output (massive MIMO), full dimensional MIMO (FD-MIMO), array antennas, analog beamforming, and large scale antennas are considered for 5G communication systems. To improve system networks in 5G communication systems, technology development is under way regarding evolved small cells, advanced small cells, cloud radio access networks (cloud RANs), ultra-dense networks, device-to-device (D2D) communication, wireless backhaul, moving networks, cooperative communication, coordinated multi-points (CoMP), interference cancellation, and the like. Additionally, advanced coding and modulation (ACM) schemes such as hybrid frequency shift keying and quadrature amplitude modulation (FQAM) and sliding window superposition coding (SWSC), and advanced access technologies such as filter bank multi carrier (FBMC), non-orthogonal multiple access (NOMA), and sparse code multiple access (SCMA) are also under development for 5G systems.

Meanwhile, the Internet is evolving from a human centered network where humans create and consume information into the Internet of Things (IoT) where distributed elements such as things exchange and process information. There has also emerged the Internet of Everything (IoE) technology that combines IoT technology with big data processing technology through connection with cloud servers. To realize IoT, technology elements related to sensing, wired/wireless communication and network infrastructure, service interfacing, and security are needed, and technologies interconnecting things such as sensor networks, machine-to-machine (M2M) or machine type communication (MTC) are under research in recent years. In IoT environments, it is possible to provide intelligent Internet technology services, which collect and analyze data created by interconnected things to add new values to human life. Through convergence and combination between existing information technologies and various industries, IoT technology may be applied to various areas such as smart homes, smart buildings, smart cities, smart or connected cars, smart grids, health-care, smart consumer electronics, and advanced medical services.

Accordingly, various attempts are being made to apply 5G communication systems to IoT networks. For example, technologies such as sensor networks and machine-to-machine (M2M) or machine type communication (MTC) are being realized by use of 5G communication technologies including beamforming, MIMO, and array antennas. Application of cloud RANs as a big data processing technique described above may be an instance of convergence of 5G technology and IoT technology.

With the advancement of mobile communication systems as described above, various services can be provided, and a method for effectively providing these services is required.

### DISCLOSURE OF INVENTION

### Technical Problem

To this end, an object of the disclosure is to provide a device and method that can effectively provide services in a mobile communication system.

More specifically, the disclosure relates to a link failure handling procedure of the boundary node when the integrated access and backhaul (IAB) system includes inter-donor dual connections.

### Solution to Problem

According to an embodiment of the disclosure to solve the above problem, a method of an integrated access and backhaul (IAB) node in a communication system may include: obtaining configuration information including backhaul adaptation protocol (BAP) header rewriting information in a state where dual connectivity (DC) is established with a first donor central unit (CU) through an F1 connection and with a second donor CU through a radio resource control (RRC) connection; performing, in response to receiving a packet from a child IAB node, a BAP header rewriting operation for the packet based on the BAP header rewriting information; identifying a first link belonging to a topology of the second donor CU to be used for routing the packet based on the BAP header rewriting operation; identifying, in response to detecting a radio link failure (RLF) in the first link, a second link belonging to a topology of the first donor CU to be used for routing the packet based on the configuration information; and routing, in case that the second link is available, the packet over the second link.

Further, according to an embodiment of the disclosure, a device of an integrated access and backhaul (IAB) node in a communication system may include: a communication part; and a controller that is configured to obtain configuration information including backhaul adaptation protocol (BAP) header rewriting information in a state where dual connectivity (DC) is established with a first donor central unit (CU) through an F1 connection and with a second donor CU through a radio resource control (RRC) connection, perform, in response to receiving a packet from a child IAB node, a BAP header rewriting operation for the packet based on the BAP header rewriting information, identify a first link belonging to a topology of the second donor CU to be used for routing the packet based on the BAP header rewriting operation, identify, in response to detecting a radio link failure (RLF) in the first link, a second link belonging to a topology of the first donor CU to be used for routing the packet based on the configuration information, and route the packet over the second link in case that the second link is available.

### Advantageous Effects of Invention

According to an embodiment of the disclosure, when an RLF occurs in one link of its dual connections, the boundary node among the nodes of the integrated access and backhaul system may not perform packet header rewriting or may transmit a failure indication to the descendant node. This has the effect of preventing routing failures by using a different bypass link without using routing for packet header rewriting.

### BRIEF DESCRIPTION OF DRAWINGS

FIG. 1 illustrates the architecture of an LTE system according to some embodiments of the present disclosure.

FIG. 2 illustrates the structure of radio protocols in the LTE system according to some embodiments of the disclosure.

FIG. 3 illustrates the architecture of a next-generation mobile communication system according to some embodiments of the disclosure.

FIG. 4 illustrates the structure of radio protocols in the next-generation mobile communication system according to some embodiments of the disclosure.

FIG. 5 illustrates the internal structure of a UE according to some embodiments of the disclosure.

FIG. 6 is a block diagram illustrating the structure of an NR base station according to some embodiments of the disclosure.

FIG. 7 is a diagram depicting a scenario to which some embodiments of the disclosure are applied.

FIG. 8 illustrates a scenario to which some embodiments of the disclosure are applied.

FIG. 9 illustrates the operation of a boundary IAB node for solution 1 when the SCG link is unavailable due to an RLF and there is no link to forward packets.

FIG. 10 illustrates solution 1 when the SCG link is unavailable due to an RLF and there is no link to forward packets.

FIG. 11 illustrates solution 2 when the SCG link is unavailable due to an RLF and there is no link to forward packets.

### MODE FOR THE INVENTION

Hereinafter, the operating principle of the present disclosure will be described in detail with reference to the accompanying drawings. In explaining the disclosure below, descriptions of well-known functions and structures incorporated herein may be omitted to avoid obscuring the subject matter of the disclosure. The terms described below are defined in consideration of their functions in the disclosure, and these may vary depending on the intention of the user, the operator, or the custom. Hence, their meanings should be determined based on the overall contents of this specification.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

For convenience of description, the disclosure uses terms and names defined in the standards for 3GPP LTE (3rd Generation Partnership Project Long Term Evolution). However, the disclosure is not limited by the above terms and names, and can be equally applied to systems conforming to other standards.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the specification to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Additionally, each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit”, “module”, or the like used in the embodiments may refer to a software component or a hardware component such as an FPGA or ASIC capable of carrying out a function or an operation. However, “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Further, components and units may be implemented to drive one or more CPUs in a device or a secure multimedia card. Also, in the embodiment, a unit or the like may include one or more processors.

In the following description of the disclosure, detailed descriptions of well-known functions and structures incorporated herein may be omitted to avoid obscuring the subject matter of the disclosure. Hereinafter, embodiments of the disclosure will be described with reference to the accompanying drawings.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used. For example, in the following description, the terminal may refer to a MAC entity within the terminal that exists for each of the master cell group (MCG) and secondary cell group (SCG) to be described later.

For convenience of description, the disclosure uses terms and names defined in the standards for 3GPP LTE (3rd Generation Partnership Project Long Term Evolution). However, the disclosure is not limited by the above terms and names, and can be equally applied to systems conforming to other standards.

In the following description, the base station (BS), as a main agent that allocates resources to a terminal, may be at least one of gNode B, eNode B, Node B, radio access unit, base station controller, or node on a network. The terminal may include, but not limited to, a user equipment (UE), a mobile station (MS), a cellular phone, a smartphone, a computer, or a multimedia system capable of performing a communication function.

In particular, the disclosure can be applied to 3GPP NR (5th generation mobile communication standards). Also, the disclosure may be applied to, based on 5G communication technology and IoT related technology, intelligent services (e.g., smart home, smart building, smart city, smart or connected car, health care, digital education, retail, security, and safety related services). In the disclosure, “eNB” may be used interchangeably with “gNB” for convenience of description. That is, a base station described as an eNB may indicate a gNB. Also, the term “terminal” may refer to a mobile phone, a NB-IoT device, a sensor, or another wireless communication device.

Wireless communication systems are evolving from early systems that provided voice-oriented services only to broadband wireless communication systems that provide high-speed and high-quality packet data services, such as systems based on communication standards including 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

As a representative example of the broadband wireless communication system, the LTE system employs orthogonal frequency division multiplexing (OFDM) in the downlink (DL) and single carrier frequency division multiple access (SC-FDMA) in the uplink (UL). The uplink refers to a radio link through which a terminal (user equipment (UE) or mobile station (MS)) sends data or a control signal to a base station (BS or eNode B), and the downlink refers to a radio link through which a base station sends data or a control signal to a terminal. In such a multiple access scheme, time-frequency resources used to carry user data or control information are allocated so as not to overlap each other (i.e., maintain orthogonality) to thereby identify the data or control information of a specific user.

As a post-LTE communication system, namely, the 5G communication system must be able to freely reflect various requirements of users and service providers and need to support services satisfying various requirements. Services considered for the 5G communication system include enhanced mobile broadband (eMBB), massive machine type communication (mMTC), and ultra-reliable and low-latency communication (URLLC).

According to some embodiments, eMBB aims to provide a data transmission rate that is more improved in comparison to the data transmission rate supported by existing LTE, LTE-A, or LTE-Pro. For example, in the 5G communication system, eMBB must be able to provide a peak data rate of 20 Gbps in the downlink and a peak data rate of 10 Gbps in the uplink from the viewpoint of one base station. At the same time, the 5G communication system has to provide an increased user perceived data rate for the terminal. To meet such requirements in the 5G communication system, it may be required to improve the transmission and reception technology including more advanced multi-antenna or multi-input multi-output (MIMO) technology. In addition, it is possible to satisfy the data transmission rate required by the 5G communication system by using a frequency bandwidth wider than 20 MHz in a frequency band of 3 to 6 GHz or 6 GHz or higher instead of a transmission bandwidth of up to 20 MHz in a band of 2 GHz currently used by LTE.

At the same time, in the 5G communication system, mMTC is considered to support application services such as the Internet of Things (IoT). For efficient support of IoT services, mMTC is required to support access of a massive number of terminals in a cell, extend the coverage for the terminal, lengthen the battery time, and reduce the cost of the terminal. The Internet of Things must be able to support a massive number of terminals (e.g., 1,000,000 terminals/km2) in a cell to provide a communication service to sensors and components attached to various devices. In addition, since a terminal supporting mMTC is highly likely to be located in a shadow area not covered by a cell, such as the basement of a building, due to the nature of the service, it may require wider coverage compared to other services provided by the 5G communication system. A terminal supporting mMTC should be configured as a low-cost terminal, and since it is difficult to frequently replace the battery of a terminal, a very long battery life time such as 10 to 15 years may be required.

Finally, URLLC, as cellular-based mission-critical wireless communication for a specific purpose, is a service usable for remote control of robots or machinery, industrial automation, unmanned aerial vehicles, remote health care, and emergency alert. Hence, URLLC should provide ultra-reliable and low-latency communication. For example, a URLLC service may have to support both an air interface latency of less than 0.5 ms and a packet error rate of 10-5 or less as a requirement. Hence, for a service supporting URLLC, the 5G system must provide a transmission time interval (TTI) shorter than that of other services, and at the same time, a design requirement for allocating a wide resource in a frequency band may be required.

The above three services considered in the 5G communication system (i.e., eMBB, URLLC, and mMTC) can be multiplexed and transmitted in one system. Here, to satisfy different requirements of the services, different transmission and reception techniques and parameters can be used. However, mMTC, URLLC, and eMBB described above are only an example of different service types, and the service types to which the disclosure is applied are not limited to the above-described examples.

Further, embodiments of the disclosure will be described by using LTE, LTE-A, LTE Pro or 5G (or, NR, next-generation mobile communication) systems as an example, but the embodiments of the disclosure may be applied to other communication systems having similar technical backgrounds or channel configurations. Also, it should be understood by those skilled in the art that the embodiments of the disclosure can be applied to other communication systems without significant modifications departing from the scope of the disclosure.

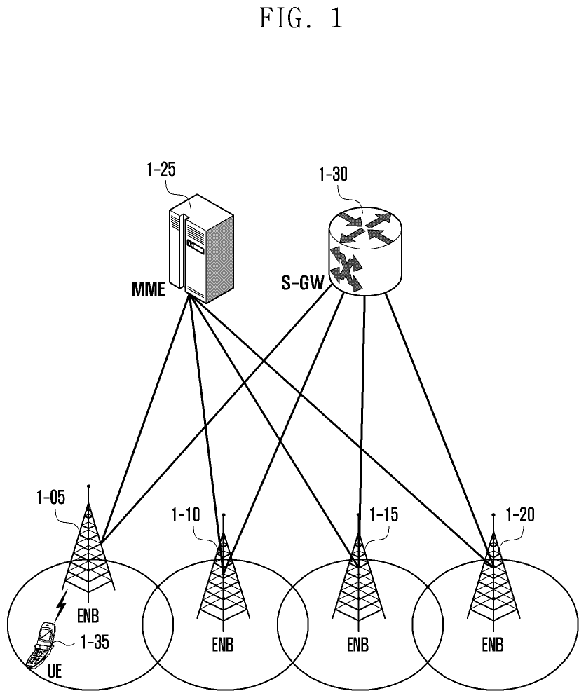

FIG. 1 illustrates the architecture of an LTE system according to some embodiments of the disclosure.

With reference to FIG. 1, as illustrated, the radio access network of the LTE system may be composed of a next-generation base station (evolved node B, ENB, Node B or base station) 1-05, 1-10, 1-15 or 1-20, a mobility management entity (MME) 1-25, and a serving-gateway (S-GW) 1-30. A user equipment (UE or terminal) 1-35 may connect to an external network through the ENB 1-05, 1-10, 1-15 or 1-20 and the S-GW 1-30.

In FIG. 1, the ENBs 1-05 to 1-20 correspond to existing Node Bs of the universal mobile telecommunication system (UMTS). The ENB is connected to the UE 1-35 through a radio channel, but performs more complex functions in comparison to the existing Node B. In the LTE system, all user traffic including real-time services like VoIP (Voice over IP) may be served through shared channels. Hence, an apparatus may be needed to perform scheduling on the basis of collected status information regarding buffers, available transmit powers and channels of the UEs, and the ENBs 1-05 to 1-20 can be responsible for this. One ENB may control multiple cells in a typical situation. To achieve a data rate of, for example, 100 Mbps in a bandwidth of, for example, 20 MHz, the LTE system may utilize orthogonal frequency division multiplexing (OFDM) as radio access technology. Also, the ENB may apply adaptive modulation and coding (AMC) to determine the modulation scheme and channel coding rate according to channel states of the UE. The S-GW 1-30 is an entity providing data bearers, and may create and remove data bearers under the control of the MME 1-25. The MME is an entity in charge of various control functions including a mobility management function for the UE, and may be connected to a plurality of ENBs.

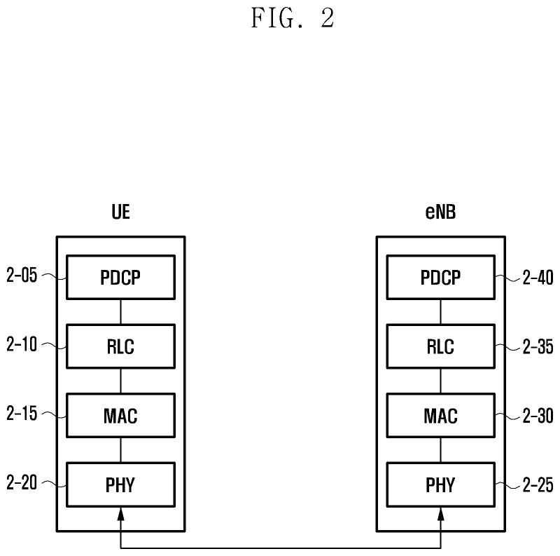

FIG. 2 illustrates the structure of radio protocols in the LTE system according to some embodiments of the disclosure.

With reference to FIG. 2, in a UE or an ENB, the radio protocols of the LTE system may include packet data convergence protocol (PDCP) 2-05 or 2-40, radio link control (RLC) 2-10 or 2-35, and medium access control (MAC) 2-15 or 2-30. The PDCP may perform compression and decompression of IP headers. The main functions of the PDCP may be summarized as follows, without being limited thereto.
Header compression and decompression function (header compression and decompression: ROHC only)
User data transfer function (transfer of user data)
In-sequence delivery function (in-sequence delivery of upper layer PDUs at PDCP re-establishment procedure for RLC AM)
Reordering function (for split bearers in DC (only support for RLC AM): PDCP PDU routing for transmission and PDCP PDU reordering for reception)
Duplicate detection function (duplicate detection of lower layer SDUs at PDCP re-establishment procedure for RLC AM)
Retransmission function (retransmission of PDCP SDUs at handover and, for split bearers in DC, of PDCP PDUs at PDCP data-recovery procedure, for RLC AM)
Cipher and decipher function (ciphering and deciphering)
Timer-based SDU discard function (timer-based SDU discard in uplink)

According to some embodiments, the radio link control (RLC) 2-10 or 2-35 may reconfigure PDCP PDUs (packet data unit) to a suitable size and perform automatic repeat request (ARQ) operation. The main functions of the RLC may be summarized as follows, without being limited thereto.
Data transfer function (transfer of upper layer PDUs)
ARQ function (error correction through ARQ (only for AM data transfer))
Concatenation, segmentation and reassembly function (concatenation, segmentation and reassembly of RLC SDUs (only for UM and AM data transfer))
Re-segmentation function (re-segmentation of RLC data PDUs (only for AM data transfer))
Reordering function (reordering of RLC data PDUs (only for UM and AM data transfer))
Duplicate detection function (duplicate detection (only for UM and AM data transfer))
Error detection function (protocol error detection (only for AM data transfer))
RLC SDU discard function (RLC SDU discard (only for UM and AM data transfer))
RLC re-establishment function (RLC re-establishment)

According to some embodiments, the MAC 2-15 or 2-30 may be connected with multiple RLC entities in a UE, and it may multiplex RLC PDUs into MAC PDUs and demultiplex MAC PDUs into RLC PDUs. The main functions of the MAC may be summarized as follows, without being limited thereto.
Mapping function (mapping between logical channels and transport channels)
Multiplexing and demultiplexing function (multiplexing/demultiplexing of MAC SDUs belonging to one or different logical channels into/from transport blocks (TB) delivered to/from the physical layer on transport channels)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

According to some embodiments, the physical (PHY) layer 2-20 or 2-25 may convert higher layer data into OFDM symbols by means of channel coding and modulation and transmits the OFDM symbols through a radio channel, or it may demodulate OFDM symbols received through a radio channel, perform channel decoding, and forward the result to an upper layer. However, it is not limited to the following examples.

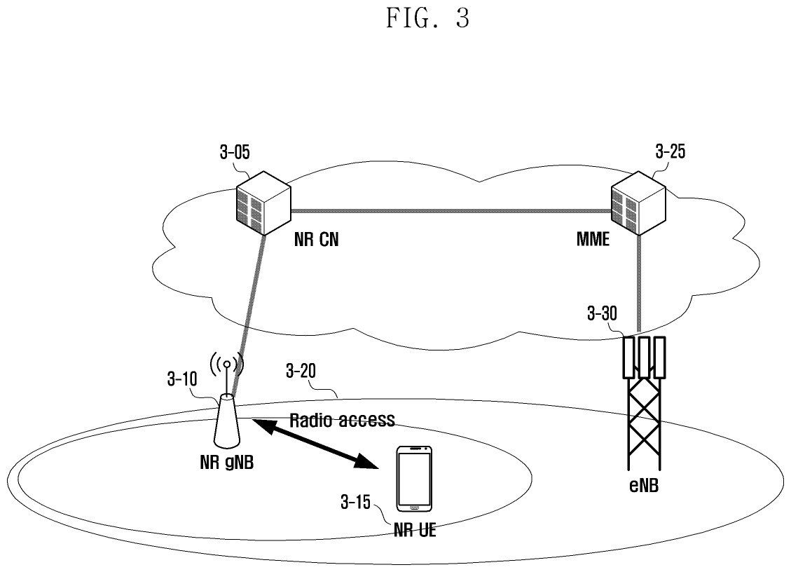

FIG. 3 illustrates the architecture of a next-generation mobile communication system according to some embodiments of the disclosure.

With reference to FIG. 3, the radio access network of a next-generation mobile communication system (hereinafter, NR or 5G) may be composed of a new radio node B (hereinafter, NR gNB or NR base station) 3-10 and a new radio core network (NR CN) 3-05. A new radio user equipment (hereinafter, NR UE or terminal) 3-15 may connect to an external network through the NR gNB 3-10 and the NR CN 3-05.

In FIG. 3, the NR gNB 3-10 may correspond to an evolved node B (eNB) of the existing LTE system. The NR gNB may be connected to the NR UE 3-15 through a radio channel, and it can provide a more superior service than that of the existing node B. All user traffic may be serviced through shared channels in the next-generation mobile communication system. Hence, there may be a need for an entity that performs scheduling by collecting status information, such as buffer states, available transmission power states, and channel states of individual UEs, and the NR gNB 3-10 may take charge of this. One NR gNB may control a plurality of cells. To implement ultra-high-speed data transmission compared with current LTE, a bandwidth beyond the existing maximum bandwidth may be utilized in the next-generation mobile communication system. Also, a beamforming technology may be additionally used with orthogonal frequency division multiplexing (OFDM) serving as a radio access technology.

Further, according to some embodiments, the NR gNB may apply an adaptive modulation and coding (AMC) scheme determining a modulation scheme and channel coding rate to match the channel state of the UE. The NR CN 3-05 may perform functions such as mobility support, bearer configuration, and quality of service (QoS) configuration. The NR CN 3-05 is an entity taking charge of not only mobility management but also various control functions for the UE, and may be connected to a plurality of base stations. In addition, the next-generation mobile communication system may interwork with the existing LTE system, and the NR CN may be connected to the MME 3-25 through a network interface. The MME may be connected to an eNB 3-30 being an existing base station.

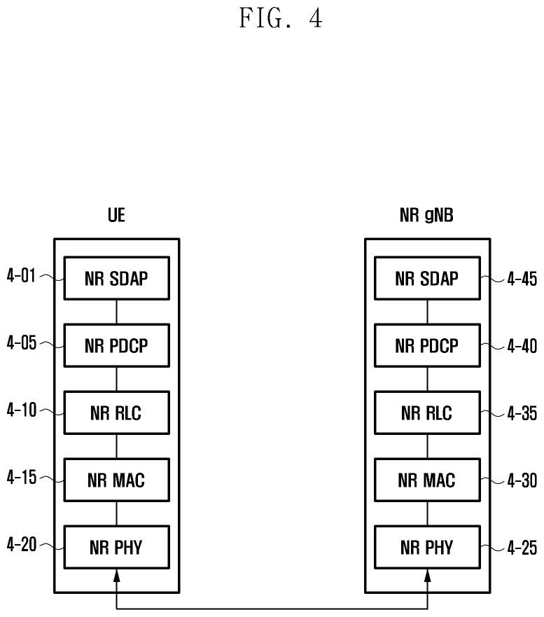

FIG. 4 illustrates the structure of radio protocols in a next-generation mobile communication system according to some embodiments of the disclosure.

With reference to FIG. 4, in a UE or an NR gNB, the radio protocols of the next-generation mobile communication system may include NR service data adaptation protocol (SDAP) 4-01 or 4-45, NR PDCP 4-05 or 4-40, NR RLC 4-10 or 4-35, and NR MAC 4-15 or 4-30.

According to some embodiments, the main functions of the NR SDAP 4-01 or 4-45 may include some of the following functions, without being limited thereto.
User data transfer function (transfer of user plane data)
Mapping function between QoS flows and data bearers for uplink and downlink (mapping between a QoS flow and a DRB for both DL and UL)
QoS flow ID marking function for uplink and downlink (marking QoS flow ID in both DL packets and UL packets)
Function of mapping reflective QoS flow to data bearer for uplink SDAP PDUs (reflective QoS flow to DRB mapping for the UL SDAP PDUs)

With respect to the SDAP entity, the UE may be configured with, through a radio resource control (RRC) message, whether to use a header of the SDAP entity or whether to use a function of the SDAP entity for each PDCP entity, bearer, or logical channel. Also, if a SDAP header is configured, the SDAP entity may use a NAS (non-access stratum) reflective QoS (quality of service) 1-bit indication and AS (access stratum) reflective QoS 1-bit indication of the SDAP header to instruct the UE to update or reconfigure the mapping information between QoS flows and data bearers for the uplink and downlink. According to some embodiments, the SDAP header may include QoS flow ID information indicating the QoS. According to some embodiments, the QoS information may be used as data processing priority and scheduling information for supporting smooth services.

According to some embodiments, the main function of the NR PDCP 4-05 or 4-40 may include some of the following functions, without being limited thereto.
Header compression and decompression function (header compression and decompression: ROHC only)
User data transfer function (transfer of user data)
In-sequence delivery function (in-sequence delivery of upper layer PDUs)
Out-of-sequence delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUs)
Cipher and decipher function (ciphering and deciphering)
Timer-based SDU discard function (timer-based SDU discard in uplink)

In the above description, the reordering function of the NR PDCP entity may mean reordering of PDCP PDUs received from a lower layer in order based on the PDCP sequence number (SN). The reordering function of the NR PDCP entity may include delivering data to an upper layer in reordered sequence, directly delivering data without considering the order, recording lost PDCP PDUs through reordering, reporting the status of lost PDCP PDUs to the transmitting side, or requesting retransmission of the lost PDCP PDUs.

According to some embodiments, the main function of the NR RLC 4-10 or 4-35 may include some of the following functions, without being limited thereto.
Data transfer function (transfer of upper layer PDUs)
In-sequence delivery function (in-sequence delivery of upper layer PDUs)
Out-of-sequence delivery function (out-of-sequence delivery of upper layer PDUs)
ARQ function (error correction through ARQ)
Concatenation, segmentation and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

In the above description, in-sequence delivery of the NR RLC entity may mean in-sequence delivery of RLC SDUs received from a lower layer to an upper layer. In-sequence delivery of the NR RLC entity may include reassembly and delivery of RLC SDUs when several RLC SDUs belonging to one original RLC SDU are received after segmentation.

In-sequence delivery of the NR RLC entity may include reordering of received RLC PDUs based on the RLC sequence number (SN) or the PDCP SN, recording lost RLC PDUs through reordering, reporting the status of the lost RLC PDUs to the transmitting side, and requesting retransmission of the lost RLC PDUs.

If there is a lost RLC SDU, in-sequence delivery of the NR RLC entity may include in-sequence delivery of only RLC SDUs before the lost RLC SDU to an upper layer.

Although there is a lost RLC SDU, if a specified timer has expired, in-sequence delivery of the NR RLC entity may include in-sequence delivery of all the RLC SDUs received before the starting of the timer to an upper layer.

Although there is a lost RLC SDU, if a specified timer has expired, in-sequence delivery of the NR RLC entity may include in-sequence delivery of all the RLC SDUs received up to now to an upper layer.

The NR RLC entity may process RLC PDUs in the order of reception regardless of the order of the sequence number, and transfer them to the NR PDCP entity in an out-of-sequence delivery manner.

In case of receiving a segment, the NR RLC entity may reconstruct one whole RLC PDU from segments stored in the buffer or received later, and transfer it to the NR PDCP entity.

The NR RLC layer may not include a concatenation function, which may be performed by the NR MAC layer or may be replaced with a multiplexing function of the NR MAC layer.

In the above description, out-of-sequence delivery of the NR RLC entity may mean a function of transferring RLC SDUs received from a lower layer directly to a higher layer regardless of their order. If several RLC SDUs belonging to one original RLC SDU are received after segmentation, out-of-sequence delivery of the NR RLC entity may include reassembly and delivery of the RLC SDUs. Out-of-sequence delivery of the NR RLC entity may include storing the RLC SNs or PDCP SNs of received RLC PDUs and ordering them to record lost RLC PDUs.

According to some embodiments, the NR MAC 4-15 or 4-30 may be connected to several NR RLC entities configured in one UE. The main function of the NR MAC may include some of the following functions, without being limited thereto.
Mapping function (mapping between logical channels and transport channels)
Multiplexing and demultiplexing function (multiplexing/demultiplexing of MAC SDUs)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The NR PHY 4-20 or 4-25 may compose OFDM symbols from higher layer data through channel coding and modulation and transmit them through a radio channel, or may demodulate and channel-decode OFDM symbols received through a radio channel and forward the result to a higher layer.

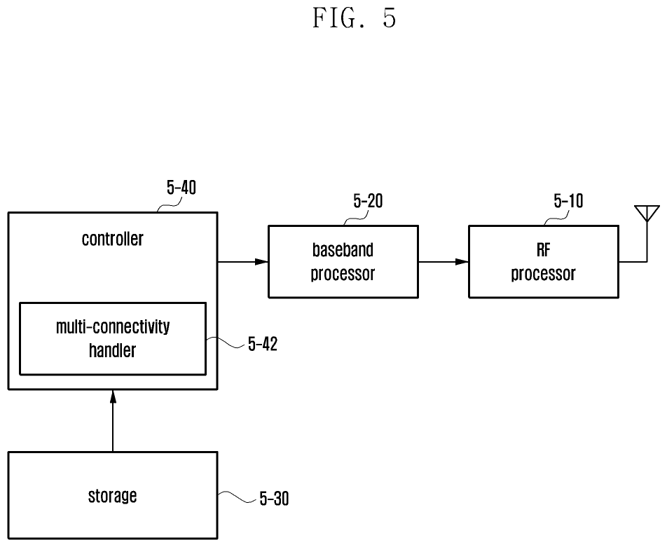

FIG. 5 is a block diagram illustrating the internal structure of a UE to which the disclosure is applied.

With reference to FIG. 5, the UE may include a radio frequency (RF) processor 5-10, a baseband processor 5-20, a storage 5-30, and a controller 5-40. Additionally, the controller 5-40 of the UE according to an embodiment of the disclosure may include a multi-connectivity handler 5-42. Without being limited to the above example, the UE may include fewer or more components than those shown in FIG. 5.

The RF processor 5-10 may perform a function for transmitting and receiving a signal through a radio channel, such as signal band conversion and amplification. That is, the RF processor 5-10 may perform up-conversion of a baseband signal provided from the baseband processor 5-20 into an RF-band signal and transmit it through an antenna, and perform down-conversion of an RF-band signal received through an antenna into a baseband signal. For example, the RF processor 5-10 may include, but not limited to, a transmission filter, a reception filter, an amplifier, a mixer, an oscillator, a digital-to-analog converter (DAC), and an analog-to-digital converter (ADC). Although only one antenna is illustrated in FIG. 5, the UE may be provided with a plurality of antennas. Also, the RF processor 5-10 may include a plurality of RF chains. Further, the RF processor 5-10 may perform beamforming. For beamforming, the RF processor 5-10 may adjust phases and magnitudes of individual signals transmitted and received through the plural antennas or antenna elements. Further, the RF processor may perform MIMO (multi input multi output), and may receive several layers during an MIMO operation.

The baseband processor 5-20 performs conversion between a baseband signal and a bit stream in accordance with the physical layer specification of the system. For example, during data transmission, the baseband processor 5-20 generates complex symbols by encoding and modulating a transmission bit stream. Further, during data reception, the baseband processor 5-20 may restore a reception bit stream by demodulating and decoding a baseband signal provided from the RF processor 5-10. For example, in the case of utilizing orthogonal frequency division multiplexing (OFDM), for data transmission, the baseband processor 5-20 generates complex symbols by encoding and modulating a transmission bit stream, maps the complex symbols to subcarriers, and composes OFDM symbols through inverse fast Fourier transform (IFFT) operation and cyclic prefix (CP) insertion. Further, for data reception, the baseband processor 5-20 may divide a baseband signal provided from the RF processor 5-10 in units of OFDM symbols, restore the signals mapped to subcarriers through fast Fourier transform (FFT) operation, and restore the reception bit stream through demodulation and decoding.

The baseband processor 5-20 and the RF processor 5-10 transmit and receive signals as described above. The baseband processor 5-20 and the RF processor 5-10 may be called a transmitter, a receiver, a transceiver, or a communication unit. Further, to support different radio access technologies, at least one of the baseband processor 5-20 or the RF processor 5-10 may include a plurality of communication modules. In addition, to process signals of different frequency bands, at least one of the baseband processor 5-20 or the RF processor 5-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz). The UE may transmit and receive signals to and from a base station by using the baseband processor 5-20 and the RF processor 5-10, and the signals may include control information and data.

The storage 5-30 stores data such as basic programs, application programs, and configuration information for the operation of the UE. In particular, the storage 5-30 may store information about a second access node that performs wireless communication using a second radio access technology. The storage 5-30 provides stored data in response to a request from the controller 5-40. The storage 5-30 may be composed of a storage medium such as ROM, RAM, hard disk, CD-ROM, DVD, or a combination thereof. Additionally, the storage 5-30 may be composed of a plurality of memories.

The controller 5-40 controls the overall operation of the UE. For example, the controller 5-40 transmits and receives signals through the baseband processor 5-20 and the RF processor 5-10. Further, the controller 5-40 writes or reads data to or from the storage 5-30. To this end, the controller 5-40 may include at least one processor. For example, the controller 5-40 may include a communication processor (CP) for controlling communication and an application processor (AP) for controlling higher layers such as application programs. Additionally, at least one component in the UE may be implemented with a single chip.

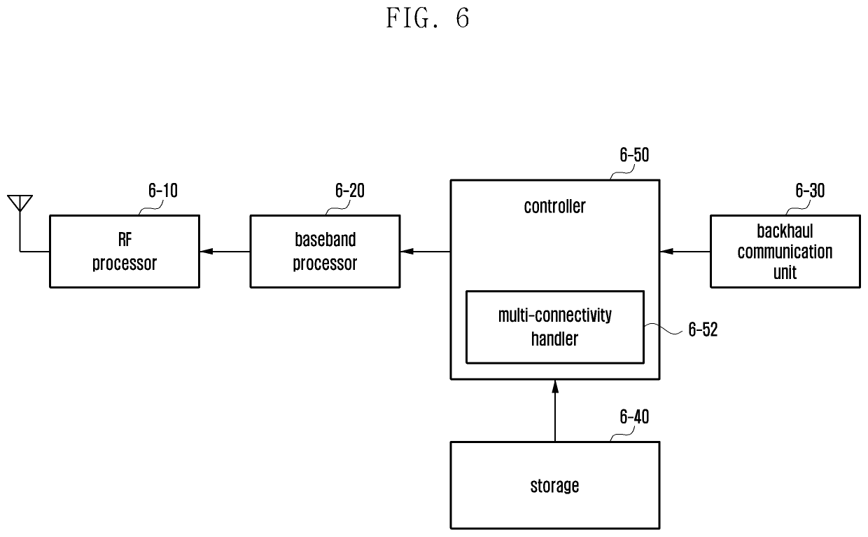

FIG. 6 is a block diagram illustrating the structure of an NR base station according to some embodiments of the disclosure.

With reference to FIG. 6, the base station may include an RF processor 6-10, a baseband processor 6-20, a backhaul communication unit 6-30, a storage 6-40, and a controller 6-50. Additionally, the controller 6-50 of the base station according to an embodiment of the disclosure may include a multi-connectivity handler 6-52. Without being limited to the above example, the base station may include fewer or more components than those shown in FIG. 6.

The RF processor 6-10 may perform a function for transmitting and receiving a signal through a radio channel, such as signal band conversion and amplification. That is, the RF processor 6-10 performs up-conversion of a baseband signal provided from the baseband processor 6-20 into an RF-band signal and transmits the converted signal through an antenna, and performs down-conversion of an RF-band signal received through an antenna into a baseband signal. For example, the RF processor 6-10 may include a transmission filter, a reception filter, an amplifier, a mixer, an oscillator, a DAC, and an ADC. Although only one antenna is illustrated in FIG. 6, the RF processor 6-10 may be provided with a plurality of antennas. Additionally, the RF processor 6-10 may include a plurality of RF chains. Further, the RF processor 6-10 may perform beamforming. For beamforming, the RF processor 6-10 may adjust phases and amplitudes of individual signals transmitted and received through plural antennas or antenna elements. The RF processor may perform downlink MIMO operation by transmitting one or more layers.

The baseband processor 6-20 may perform conversion between a baseband signal and a bit stream in accordance with the physical layer specification of a first radio access technology. For example, for data transmission, the baseband processor 6-20 may generate complex symbols by encoding and modulating a transmission bit stream. Further, for data reception, the baseband processor 6-20 may restore a reception bit stream by demodulating and decoding a baseband signal provided from the RF processor 6-10. For example, in the case of utilizing OFDM, for data transmission, the baseband processor 6-20 generates complex symbols by encoding and modulating a transmission bit stream, maps the complex symbols to subcarriers, and composes OFDM symbols through IFFT operation and CP insertion. Further, for data reception, the baseband processor 6-20 may divide a baseband signal provided from the RF processor 6-10 in units of OFDM symbols, restore the signals mapped to subcarriers through FFT operation, and restore the reception bit stream through demodulation and decoding. The baseband processor 6-20 and the RF processor 6-10 may transmit and receive signals as described above. Hence, the baseband processor 6-20 and the RF processor 6-10 may be called a transmitter, a receiver, a transceiver, a communication unit, or a wireless communication unit. The base station may transmit and receive signals to and from a UE by using the baseband processor 6-20 and the RF processor 6-10, and the signals may include control information and data.

The backhaul communication unit 6-30 provides an interface for communication with other nodes in the network. That is, the backhaul communication unit 6-30 may convert a bit stream, which is to be transmitted from the primary base station to another node, for example, a secondary base station or the core network, into a physical signal, and convert a physical signal received from another node into a bit stream. The backhaul communication unit 6-30 may be included in a communication unit.

The storage 6-40 stores data such as basic programs, application programs, and configuration information for the operation of the base station. In particular, the storage 6-40 may store information on a bearer allocated to a connected UE and measurement results reported from the connected UE. Further, the storage 6-40 may store information used as a criterion for determining whether to provide or suspend multi-connectivity to the UE. In addition, the storage 6-40 provides stored data in response to a request from the controller 6-50. The storage 6-40 may be composed of a storage medium such as ROM, RAM, hard disk, CD-ROM, DVD, or a combination thereof. Additionally, the storage 6-40 may be composed of a plurality of memories. According to some embodiments, the storage 6-40 may store a program for executing a buffer status reporting scheme according to the disclosure.

The controller 6-50 controls the overall operation of the base station. For example, the controller 6-50 transmits and receives signals through the baseband processor 6-20 and the RF processor 6-10 or through the backhaul communication unit 6-30. Further, the controller 6-50 writes or reads data to or from the storage 6-40. To this end, the controller 6-50 may include at least one processor. Additionally, at least one component of the base station may be implemented with a single chip.

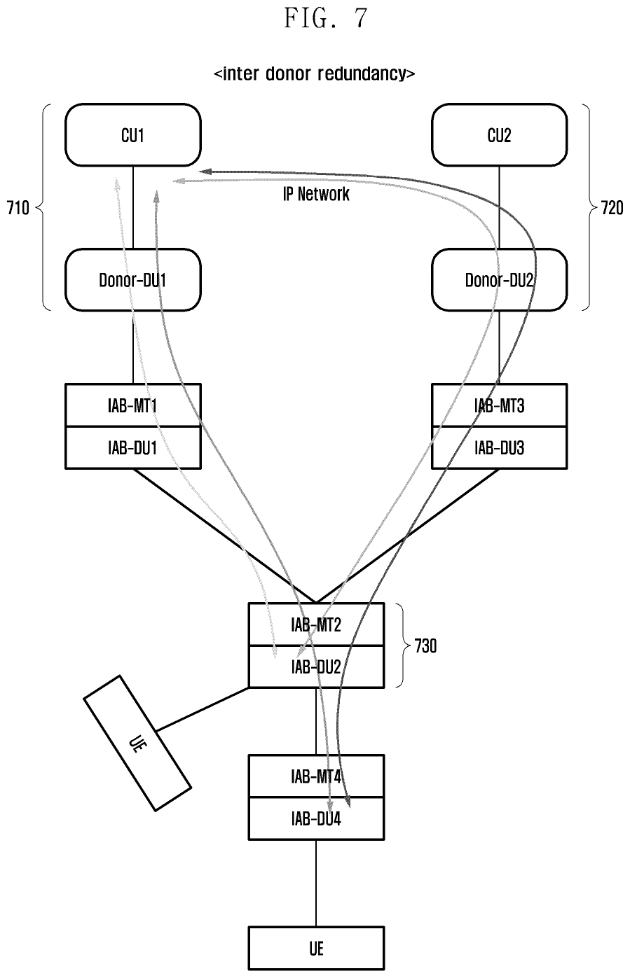

FIG. 7 illustrates a scenario to which some embodiments of the disclosure are applied.

In this case, there are two IAB donors, donor 1 (710) and donor 2 (720), and they manage their respective topologies; IAB node 2 (730) as a boundary node becomes a junction point of the topologies of donor 1 (710) and donor 2 (720). However, the f1 termination point of IAB node 2 (730) is donor 1 (710), and donor 1 (710) is the destination point and source point of backhaul traffic. Instead, the master cell group (MCG) link of the RRC entity of the boundary node is donor 1 (710), and the secondary cell group (SCG) link is donor 2 (720). Hence, after the dual connectivity of the boundary IAB node is established, some of the backhaul traffic of donor 1 (710) may be transmitted/received through the topology of donor 2 (720). For example, the backhaul traffic of donor 1 (710) may be offloaded through the topology of donor 2 (720) according to the need for offloading. To this end, donor 1 (710) may share topology-related information of donor 2 (720), and by utilizing the routing information of backhaul packets that will use the topology of donor 2 (720), routing ID information for packet rewriting and routing information reflecting the topology of donor 2 (720) to be applied after rewriting may be transmitted to the boundary IAB node. This transfer may be performed through donor 1 (710), or may be performed directly by donor 2 (720). When the boundary IAB node receives a DL or UL BAP packet, it identifies the routing ID information for packet rewriting, and if the routing ID included in the packet header is the routing ID for rewriting, it rewrites the packet header by applying the routing ID at the corresponding target node. In the case of UL, after rewriting, the packet is routed to the topology of donor 2 (720) by using a routing table reflecting the topology information of donor 2 (720), and donor 2 (720) transmits the packet back to donor 1 (710) through an IP network.

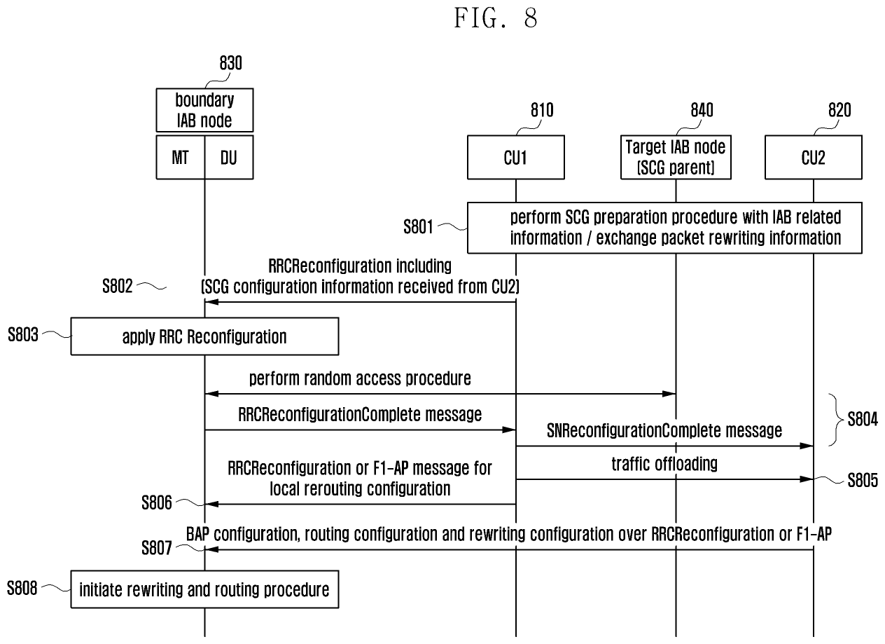

FIG. 8 is a sequence diagram of a scenario to which some embodiments of the disclosure are applied.

The flow of FIG. 8 will be described based on the scenario of FIG. 7. For example, the CU of donor 1 will be called CU1 (810), and the CU of donor 2 will be called CU2 (820). CU1 (810) and IAB node 830 perform the SCG preparation procedure with CU2 (820) while maintaining the connected state, and CU1 (810) and CU2 (820) share routing ID information for packet rewriting (S801). At this time, CU1 (810) may transmit an Xn message including an indication that packet offload will be performed to CU2 (820). CU1 (810) may receive SCG configuration information from CU2 (820) and forward it to the IAB node 830 (S802).

Upon receiving this information, the IAB node 830 may apply the RRC configuration information (S803) and attempt to connect to the target IAB node 840 (corresponding to IAB node 3 including IAB MT-3 and DU-3 in FIG. 7) being the target parent node under the topology of CU2 (820). More specifically, the IAB node 830 may perform a random access procedure with the target IAB node 840, and if the random access is successful, it may transmit an RRCReconfigurationComplete message to CU1 (810). Based on transmission of this message, the IAB node 810 may operate as a boundary node. Additionally, CU1 (810) may deliver a SNReconfiguratoinComplete message to CU2 (820). Thereby, DC configuration may be completed (S804). Further, based on transmission of the SNReconfiguratoinComplete message, CU1 (810) may perform traffic offloading to CU2 (820) (S805). Upon receiving the SNReconfiguratoinComplete message from CU1 (810), CU2 (820) may determine that SCG addition is complete and may transmit packet rewriting information and routing information to the IAB node 830. This information may be delivered from CU2 (820) to the IAB node 830 through an RRC message or F1AP (S807). After receiving this information, the IAB node 830 may perform packet header rewriting and a routing procedure based on the corresponding rewritten routing ID for BAP traffic using the topology of CU2 820 (S808).

Meanwhile, after the IAB node 830 transmits the RRCReconfigurationComplete message indicating completion of SCG addition to CU1 (810), CU1 (810) may assume that dual connectivity is completed and may transmit routing configuration information for local rerouting to the IAB node 830 through an RRCReconfiguration or F1AP message (S806).

### Problem Situation to be Addressed

In the above case, the MCG and SCG links of the IAB node 830 with dual connectivity are set in correspondence to respective RRCs of CU1 (810) and CU2 (820). Each CU manages its own topology information, BAP address of each node, and routing ID toward each node. If CU1 (810) intends to offload specific BAP packets to the topology of CU2 (820), it may, through CU2 (820) or by itself, deliver rewriting information, including information on routing IDs of BAP packets to be offloaded and information on a target routing ID to be used by replacing the routing ID, to the IAB node 830. Also, CU2 (820) may deliver routing information reflecting the topology of CU2 (820) to the IAB node 830.

Upon receiving these information, the boundary IAB node 830, for DL traffic received through the SCG link and UL traffic received from the child node, rewrites the headers of packets corresponding to the previous routing ID included in the rewriting information with the routing ID to be used in the target topology, and performs routing by applying a routing table based on the target topology.

In this case, if a radio link failure (RLF) occurs in the SCG link, as there is only one egress link in the UL direction, the SCG link, in the routing information based on the target topology of the boundary IAB node, there is no link to forward packets when the egress link becomes unavailable due to an RLF. As a result, UL packets may be buffered or discarded at the boundary IAB node.

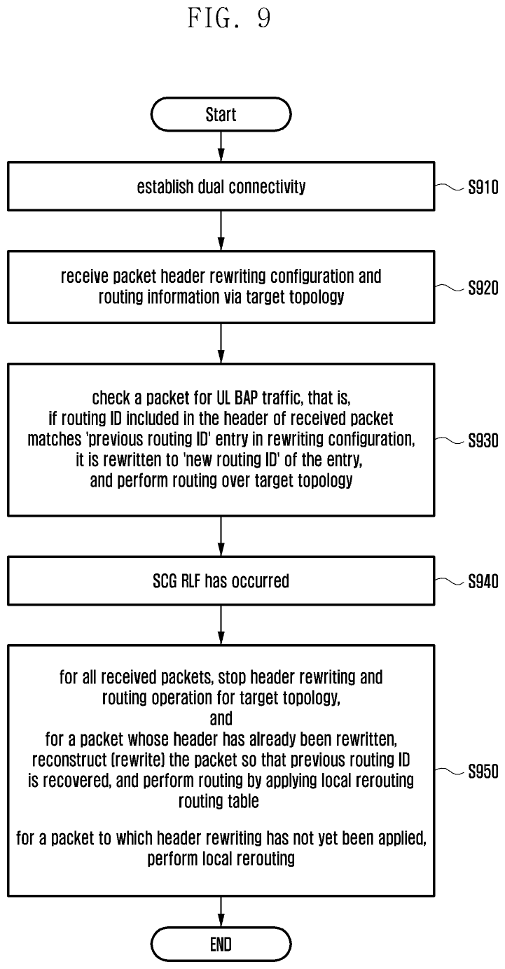

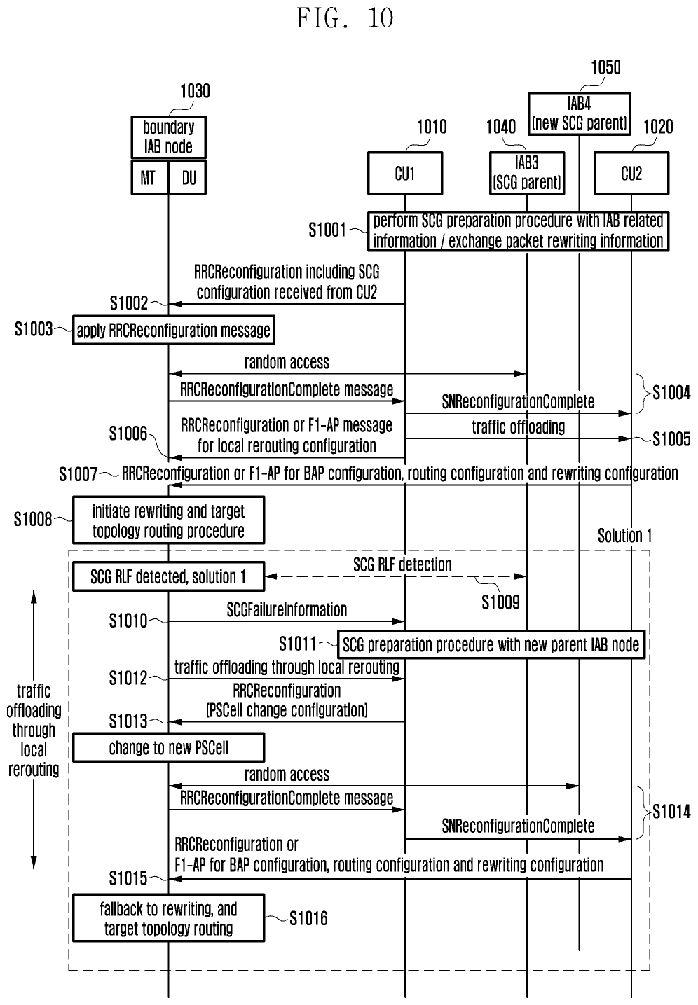

As a way to solve this problem, the disclosure proposes the following scheme. FIG. 9 is a flowchart depicting operations of the boundary IAB node for solution 1 to be described below, and FIG. 10 is a sequence diagram for solution 1 to be described below.

### 1. Solution 1

A. Packet rewriting and routing to the target topology are not performed in existing inter donor redundancy.
   i. Previously, upon receiving packet header rewriting information and routing table information about the target topology, the routing ID of the BAP header received from UL/DL is identified to check whether it is mapped to the ‘previous routing ID’ of the rewriting information; if they match, the routing ID is rewritten to a new routing ID corresponding to the matching previous routing ID, and packet routing is performed subject to the new routing ID by applying the routing table of the target topology. However, in this proposal,
      1. For packets that have already been rewritten,
         A. If an RLF occurs in the SCG link while performing the rewriting operation, the rewriting operation and the routing operation based on the target topology are stooped, and the packet header is rewritten again with the previous routing ID before being rewritten. And;
         B. If the SCG link is unavailable, routing may be performed by using a local re-routing table in use. (In most cases, local re-routing table information is provided in advance so that the MCG link can be used as a backup egress link)
      2. For packets that have not yet been rewritten among the received BAP packets,
         A. The rewriting operation and routing operation based on the target topology are not performed.
         B. If the SCG link is unavailable, routing may be performed by using a local re-routing table in use. (In most cases, local re-routing table information is provided in advance so that the MCG link can be used as a backup egress link)
      3. If the RLF in the SCG link is recovered, the rewriting operation and routing operation based on the target topology are performed again. In BAP operation, it can be expressed that packet header rewriting and target topology routing are performed when the egress link to the target topology becomes available.

FIG. 9 illustrates operations of the boundary IAB node carrying out solution 1 described above according to an example of the disclosure. More specifically, with reference to FIG. 9, the boundary IAB node may be dual-connected to the topology of CU1 and the topology of CU2 (S910).

Then, in a state where dual connectivity is established, the boundary IAB node may receive a packet header rewriting configuration and routing information via the target topology (topology of CU2) (S920). Thereafter, when a packet for uplink (UL) BAP traffic is received from the child IAB node, the boundary IAB node may check the header of the packet to perform a packet header rewriting operation. More specifically, if the routing ID included in the header of the packet matches the “previous routing ID” in the packet header rewriting configuration, the boundary IAB node according to an example of the disclosure may rewrite the header of the packet with a new routing ID corresponding to the previous routing ID. Then, the boundary IAB node may perform routing for the packet whose header is rewritten by using routing information based on the target topology (S930).

Thereafter, an RLF may occur in a link belonging to the target topology, that is, SCG link (S940).

When an RLF has occurred as to the SCG, the boundary IAB node according to an example of the disclosure may stop the header rewriting operation and the routing operation based on the target topology for all received packets. Then, for a packet whose header has already been rewritten, the boundary IAB node may reconstruct (rewrite) the packet's header so that the “previous routing ID” having been included in the packet before rewriting is recovered. Here, the recovery operation may be performed based on the configuration information previously obtained according to the topology of the first donor CU. More specifically, the recovery operation may refer to an operation for identifying the routing ID mapped to the BAP address (next hop's address) of the egress link to be used to forward the packet from the configuration information and reconstructing the header by using the identified routing ID. Then, routing may be performed for the packet reconstructed in this way by applying the local rerouting configuration (routing table) based on the topology of the first CU. Otherwise, for at least one packet for which the rewriting operation has not yet been performed among the received packets, routing may be performed based on the local rerouting configuration (routing table) without a separate header rewriting operation (S950).

FIG. 10 is a diagram showing the operations described above as overall interactions between nodes. With reference to FIG. 10, a first donor CU (CU1) 1010 may perform an SCG preparation procedure with a second donor CU (CU2) 1020 by using IAB-related information (S1001). Then, CU1 (1010) may transmit an RRCReconfiguration message including the SCG configuration obtained from CU2 (1020) to a boundary IAB node 1030. The boundary IAB node 1030 according to an example of the disclosure may apply the obtained RRCReconfiguration message (S1003), and may accordingly perform a random access procedure with a parent IAB node 1040 based on the topology of CU2 (1020). If the random access procedure is successfully completed, the boundary IAB node 1030 may transmit an RRC RRCReconfigurationComplete message to CU1 (1010), and CU1 (1010) may correspondingly transmit a SNReconfigurationComplete message to CU2 (1020), thereby completing DC setup for the boundary IAB node 1030 (S1004). In addition, because of this, CU1 (1010) may offload traffic to CU2 (1020) (S1005).

Meanwhile, CU1 (1010) according to an example of the disclosure may transmit configuration information for local routing based on the topology of CU1 to the boundary IAB node 1030 (S1006). This configuration information may be transmitted through an RRCReconfiguration message or F1AP message. Additionally, based on the DC setup, CU2 (1020) may transmit information about BAP configuration, routing configuration, and rewriting configuration based on the topology of CU2 to the boundary IAB node 1030 through an RRCReconfiguration message or F1AP message (S1007). However, this information may be transmitted via CU1 (1010) to the boundary IAB node 1030. Thereafter, based on the received configuration information, the boundary IAB node 1030 may perform a rewriting operation and a routing procedure to the target topology for the packet (S1008).

Meanwhile, when the boundary IAB node 1030 detects a radio link failure (RLF) in a link belonging to the target topology, for example, a link to the SCG parent IAB node 1040 (S1009), it may transmit this information (e.g., SCGFailureInforamtion) to CU1 (1010) (S1010). Upon receiving this information, CU1 (1010) may perform an SCG preparation procedure to establish DC with CU2 (1020) and the new parent IAB node 1050 (S1011). Additionally, in response to SCG RLF detection, the boundary IAB node 1030 may offload traffic to a link belonging to the topology of CU1 (1010) through local rerouting (S1012).

Thereafter, when the PSCell is changed, CU1 (1010) may transmit RRCReconfiguration including the PSCell change configuration to the boundary IAB node 1030 (S1013), and a new PSCell 1050 can be configured accordingly. The boundary IAB node 1030 may perform a random access procedure with the new PSCell 1050, and if the random access procedure is successfully completed, DC including the new PSCell 1050 may be setup (S1014). Thereafter, CU2 may transmit a BAP configuration, routing configuration, and rewriting configuration based on the changed PSCell 1050 to the boundary IAB node 1030 (S1015); the boundary IAB node 1030 performing traffic offloading through a local rerouting operation may fall back to the rewriting operation to perform a target topology routing operation based on the newly received configuration (S1016).

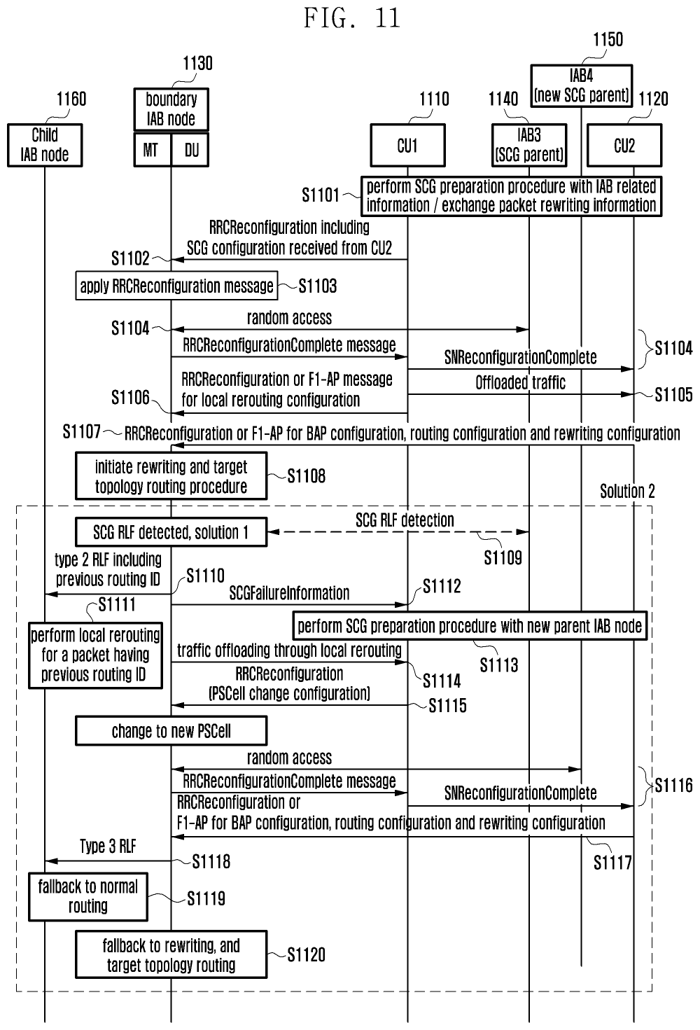

FIG. 11 is a sequence diagram for solution 2 to be described below.

### 2. Solution 2

A. If an RLF occurs in the SCG link, the boundary IAB node may transmit a type 2 RLF indication (RLF detection indication) to the child node. This indicator may additionally include at least one piece of the following information.
   i. Inter donor boundary node failure indication
   ii. Indication of whether RLF is in MCG link or SCG link
   iii. Routing IDs of BAP packets scheduled to be routed to the corresponding SCG link, i.e., “previous routing IDs” in packet header rewriting information, and BAP destination address information for each routing ID
B. Packets that have already been packet rewritten are buffered at the boundary IAB node until the RLF is recovered.
C. The child node that receives the type 2 RLF indication above may perform the following operation.
   i. Local rerouting may be performed for a BAP packet having a routing ID matching the ‘previous routing ID’ received together, so that the BAP packet is not transmitted to the corresponding boundary IAB node but is transmitted to another available parent node.
   ii. If the boundary IAB node's SCG link is recovered from the RLF situation, the boundary IAB node may transmit a type 3 RLF indication (i.e., RLF recovery indication) to the child node to which the type 2 RLF indication has been transmitted. The child node receiving the corresponding indication does not perform local rerouting but falls back to the state before receiving the type 2 RLF indication.

More specifically, overall interactions between nodes to perform operations based on solution 2 described above will be depicted with reference to FIG. 11. However, detailed descriptions of procedures identical to those of FIG. 10 will be omitted.

With reference to FIG. 11, CU1 (1110) and CU2 (1120) may perform the SCG preparation procedure in a manner described above by using IAB-related information (S1101); the boundary IAB node 1130 may receive the SCG configuration provided by CU2 (1120) from CU1 (1110) through the SCG preparation procedure (S1102), apply the corresponding RRC configuration (S1103), and perform a random access procedure with the parent IAB node 1140 in the topology of CU2 to complete DC setup (S1104). Then, because of this, CU1 (1110) may perform traffic offloading to CU2 (1120) (S1105).

The boundary IAB node 1130 according to an example of the disclosure may receive a message for local rerouting configuration from CU1 (1110) (S1106), receive information about BAP configuration, routing configuration, and rewriting configuration from CU2 (1020) based on the DC setup (S1107), and then perform a rewriting operation and a routing procedure to the target topology for packets (S1108).

Meanwhile, the boundary IAB node 1130 may detect a radio link failure (RLF) in a link belonging to the target topology, for example, a link to the SCG parent IAB node 1140 (S1109). Here, the boundary IAB node 1130 may directly detect that an RLF has occurred in the link to the SCG parent IAB node 1140, or may detect it by receiving an RLF detection indication for the link from the SCG parent IAB node 1140. When an RLF is detected in this way, the boundary IAB node 1130 may transmit a type 2 RLF indication to the child IAB node 1160 (S1110). Here, the type 2 RLF indication may include, for example, information about the routing ID before header rewriting. Upon receiving this, the child IAB node 1160 may determine that routing of the packet through the boundary IAB node 1130 is not available, and may perform a local rerouting operation for the packet with the previous routing ID (S1111).

Additionally, the boundary IAB node 1130 may transmit information about the SCG RLF (e.g., SCGFailureInforamtion) to CU1 (1110) (S1112). Upon receiving this information, CU1 (1110) may perform an SCG preparation procedure with CU2 (1120) to establish DC to the new parent IAB node 1150 (S1113), and the boundary IAB node 1130 may offload traffic to a link belonging to the topology of CU1 (1110) through local rerouting in response to SCG RLF detection (S1114).

Thereafter, when the PSCell is changed, CU1 (1110) may transmit RRCReconfiguration including the PSCell change configuration to the boundary IAB node 1130 (S1115), and a new PSCell 1150 can be configured accordingly. The boundary IAB node 1130 may perform a random access procedure with the new PSCell 1150, and if the random access procedure is successfully completed, DC including the new PSCell 1150 may be setup (S1116). Thereafter, CU2 (1120) may transmit a BAP configuration, routing configuration, and rewriting configuration based on the changed PSCell 1150 to the boundary IAB node 1130 (S1117); the boundary IAB node 1130 performing traffic offloading through a local rerouting operation may transmit a type 3 RLF indication indicating that the RLF has been recovered to the child IAB node 1160 (S1118). Accordingly, the child IAB node 1160 may fall back to the normal routing operation (S1119) to route packets to the boundary IAB node 1130, and the boundary IAB node 1130 may fall back to the rewriting operation to perform a routing operation based on the topology of CU2 (1120) (S1120).

### 3. Solution 3

A. When an RLF occurs in the SCG egress link, the boundary IAB node performs buffering for BAP packets corresponding to the ‘previous routing ID’ in the header rewriting configuration information. At the time when the RLF is recovered, the boundary IAB node may perform header rewriting and routing based on the target topology.

Meanwhile, specific embodiments have been described in the detailed description of the disclosure, but various modifications are possible without departing from the scope of the disclosure. Therefore, the scope of the disclosure should not be limited to those embodiments described herein, but should be determined by the scope of the appended claims and their equivalents.

1. A method performed by an integrated access and backhaul (IAB) node in a communication system, the method comprising:
receiving, from a first donor central unit (CU), configuration information including backhaul adaptation protocol (BAP) header rewriting information, wherein dual connectivity (DC) is configured for the IAB node with the first donor CU through an F1 connection and with a second donor CU through a radio resource control (RRC) connection;
in case that a packet to be transmitted is identified, performing a BAP header rewriting operation for the packet based on the BAP header rewriting information;
identifying whether a first link belonging to a topology of the second donor CU is available for routing the packet based on the BAP header rewriting operation;
in case that a radio link failure (RLF) is detected for the first link, identifying, a second link belonging to a topology of the first donor CU to be used for routing the packet based on the configuration information; and
in case that the second link is available, routing the packet on the second link.

2. The method of claim 1,
wherein the BAP header rewriting information includes information on a mapping between a first routing identity (ID) associated with the topology of the first donor CU and a second routing ID associated with the topology of the second donor CU, and
wherein the BAP header rewriting operation comprises, in case that a routing ID included in a header of the packet corresponds to the first routing ID, an operation of rewriting the header of the packet with the second routing ID.

3. The method of claim 1,
wherein the second link is identified by routing information included in the configuration information, the routing information being based on the topology of the first donor CU, and
wherein routing the packet on the second link further comprises constructing the header of the packet on which the BAP header rewriting operation has been performed based on the routing information.

4. The method of claim 1, wherein the configuration information is received from the first donor CU through an F1AP message.

5. The method of claim 1, further comprising:
identifying an RLF recovery for the first link; and
in case that another packet associated with the first link is received from a child IAB node, performing the BAP header rewriting operation for the other packet based on the RLF recovery.

6. The method of claim 1, further comprising:
transmitting, to a child node, an RLF detection indication indicating that the RLF is detected.

7. The method of claim 6, wherein the RLF detection indication includes at least one of an inter-donor boundary node failure indication, information indicating a donor CU's topology to which a link where the RLF has occurred belongs, or routing ID information corresponding to the first link.

8. An integrated access and backhaul (IAB) node in a communication system, the IAB node comprising:
a transceiver; and
a controller configured to:
receive, from a first donor central unit (CU), configuration information including backhaul adaptation protocol (BAP) header rewriting information, wherein dual connectivity (DC) is configured for the IAB node with the first donor CU through an F1 connection and with a second donor CU through a radio resource control (RRC) connection,
in case that a packet to be transmitted is identified, perform a BAP header rewriting operation for the packet based on the BAP header rewriting information,
identify whether a first link belonging to a topology of the second donor CU is available for routing the packet based on the BAP header rewriting operation,
in case that a radio link failure (RLF) is detected for the first link, identify a second link belonging to a topology of the first donor CU to be used for routing the packet based on the configuration information, and
in case that the second link is available, route the packet on the second link.

9. The IAB node of claim 8,
wherein the BAP header rewriting information includes information on a mapping between a first routing identity (ID) associated with the topology of the first donor CU and a second routing ID associated with the topology of the second donor CU, and
wherein the BAP header rewriting operation comprises, in case that a routing ID included in a header of the packet corresponds to the first routing ID, an operation of rewriting the header of the packet with the second routing ID.

10. The IAB node of claim 8,
wherein the second link is identified by routing information included in the configuration information, the routing information being based on the topology of the first donor CU, and
wherein the controller is configured to construct the header of the packet on which the BAP header rewriting operation has been performed based on the routing information.

11. The IAB node of claim 8, wherein the configuration information is received from the first donor CU through an F1AP message.

12. The IAB node of claim 8, wherein the controller is configured to identify an RLF recovery for the first link, and in case that another packet associated with the first link is received from a child IAB node, perform the BAP header rewriting operation for the other packet based on the RLF recovery.

13. The IAB node of claim 8, wherein the controller is configured to control the transceiver to transmit, to a child node, an RLF detection indication indicating that the RLF is detected.

14. The IAB node of claim 13, wherein the RLF detection indication includes at least one of an inter-donor boundary node failure indication, information indicating a donor CU's topology to which a link where the RLF has occurred belongs, or routing ID information corresponding to the first link.
